(19) United States
(12) Patent Application Publication
(10) Pub. No.: US 2016/0122121 A1
(43) Pub. Date: May 5, 2016

(54) Pre-sweetened tea bag

(71) Applicant: Theresa Manley, Vidor, TX (US)

(72) Inventor: Theresa Manley, Vidor, TX (US)

(21) Appl. No.: 14/933,081

(22) Filed: Nov. 5, 2015

Related U.S. Application Data
(60) Provisional application No. 62/075,329, filed on Nov. 5, 2014.

(51) Int. Cl. B65D 85/808; A23F 3/30

(52) U.S. Cl. CPC B65D 85/808; A23F 3/30

(57) ABSTRACT

A pre-sweetened tea bag contains pre-measured quantities of tea and a sweetener, such as sugar or Sweet'N Low®. The tea is provided in a broad assortment of flavors and varieties, and is provided in both individual serving tea bags, and a large tea bag for restaurants and other institutions. Alternatively, the pre-measured sweetener may be provided in a separate sweetener bag of the same size and the same material, which is affixed side-by-side to the tea bag.

### CROSS-REFERENCE TO RELATED APPLICATIONS

This Application claims the benefit of U.S. Provisional Application No. 62/075,329, filed Nov. 5, 2014, which is hereby incorporated by reference.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to foods and beverages, and in particular to a pre-sweetened tea bag. A broad assortment of tea varieties is available in convenient tea bags for individual use. Larger tea bags are also available for restaurants and other institutions, and the pre-measured quantity of tea contained it is own filter saves time and money. Unfortunately, sweeteners such as sugar and Sweet'N Low®. must still be carefully measured. A pre-sweetened tea bag, containing pre-measured tea and a selected sweetener for individual or institutional use, would resolve this problem.

### SUMMARY OF THE INVENTION

Accordingly, the invention is directed to a pre-sweetened tea bag. The tea formulation which is contained in the tea bag is composed of pre-measured quantities of tea and a sweetener, such as sugar or Sweet'N Low®. The tea is provided in a broad assortment of flavors and varieties, and is provided in both individual serving tea bags, and a large tea bag for restaurants and other institutions. Alternatively, the pre-measured sweetener may be provided in a separate sweetener bag of the same size and the same material, which is affixed side-by-side to the tea bag.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWINGS

The accompanying drawings are included to provide a further understanding of the invention and are incorporated into and constitute a part of the specification. They illustrates three embodiments of the invention and, together with the description, serve to explain the principles of the invention.

FIG. 1 is a front perspective view of the first exemplary embodiment, displaying the tea bag 10, and the label 11.

FIG. 2 is a front perspective view of the second exemplary embodiment, displaying the tea bag 10, the sweetener bag 10A, and the label 11.

FIG. 3 is a front perspective view of the third exemplary embodiment, displaying the large tea bag 12.

FIG. 4 is a front perspective view of the fourth exemplary embodiment, displaying the large tea bag 12 showing a sweetener section 14 and a tea section 15 separated by a divider 16.

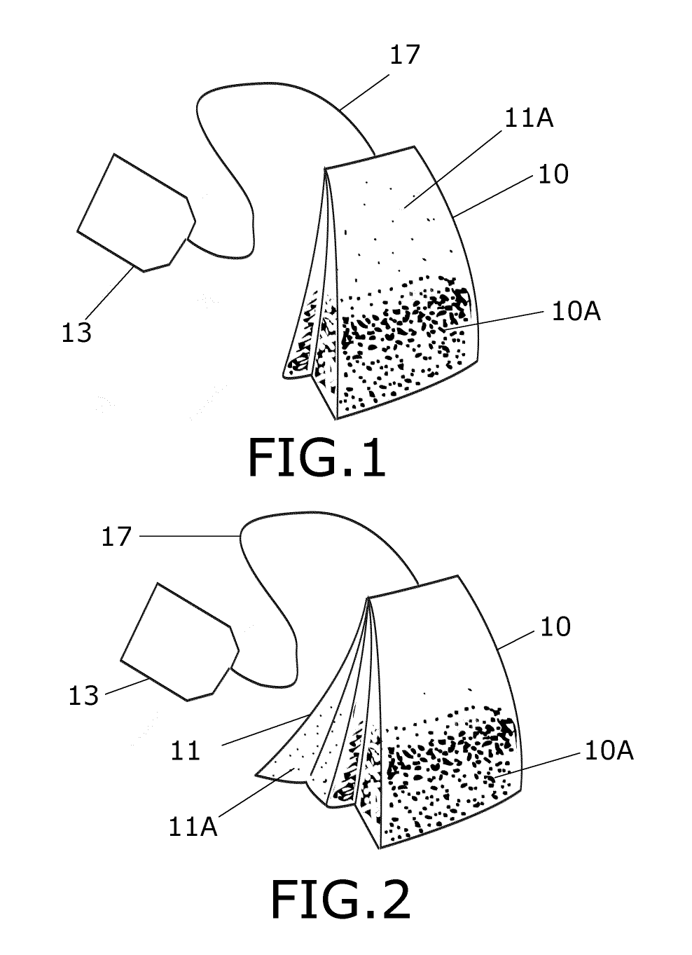

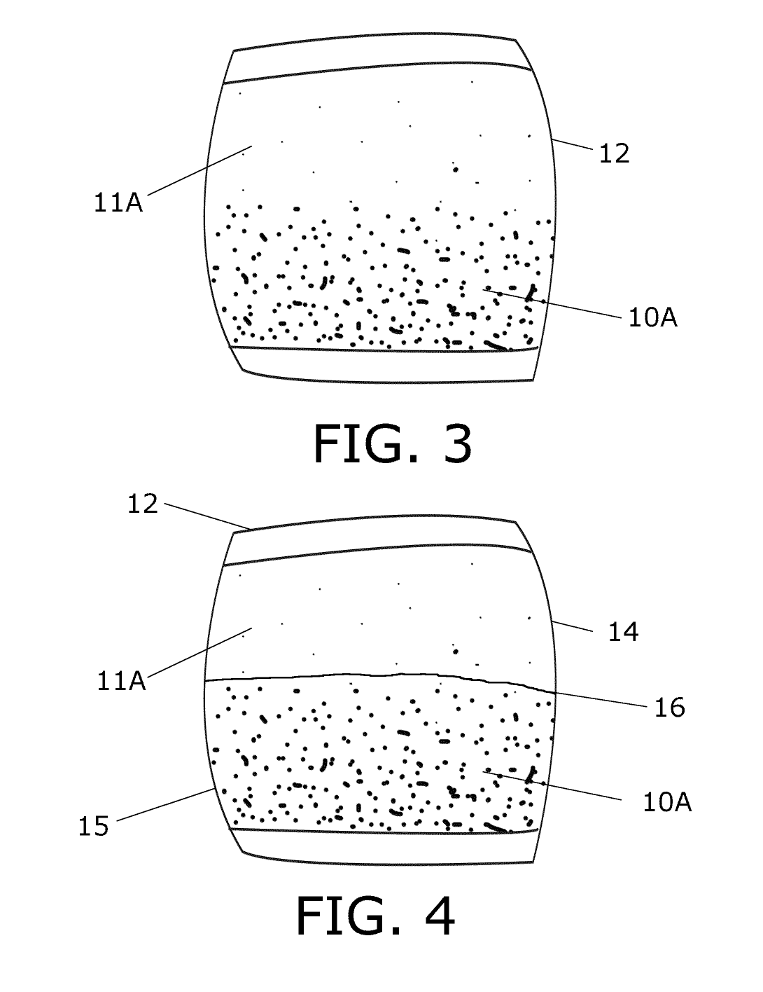

### DETAILED DESCRIPTION OF THE INVENTION

Referring now to the invention in more detail, the invention is directed to a pre-sweetened tea bag 10. The tea formulation which is contained in the tea bag 10 is composed of pre-measured quantities of tea 10A and a sweetener 11A, such as sugar or Sweet'N Low®. The tea 10A is provided in a broad assortment of flavors and varieties, and is provided in both individual serving tea bags 10, and a large tea bag 12 for restaurants and other institutions. Alternatively, the pre-measured sweetener 11A may be provided in a separate sweetener bag 11 of the same size and the same material, which is affixed side-by-side to the tea bag 10.

The first exemplary embodiment comprises a formulation which is composed of pre-measured quantities of tea 10A and a sweetener 11A, contained in an otherwise conventional single serving tea bag 10 with a label 13 which is connected with a string 17. Preferably, a plurality of tea bags 10, such as 48 tea bags 10, are provided in individual packets in a box.

The second exemplary embodiment comprises a pre-measured quantity of tea 10A in a tea bag 10, and a pre-measured quantity of sweetener 11A in a sweetener bag 11 of the same size and same material as the tea bag 10. The tea bag 10 and the sweetener bag 11 are affixed together and provided with a label 13, in the same manner as a conventional tea bag. Preferably, a plurality of tea bags 10, each with a sweetener bag 11 affixed, are provided in individual packets in a box.

To use the first or the second exemplary embodiment, the user opens the packet and places the tea bag 10, either alone or with the sweetener bag 11 affixed, in a cup with the label 13 hanging over the side of the cup. The user then pours hot water into the cup and agitates the tea bag 10, either by stirring the water or dipping the tea bag 10 by holding the label 13, until the sweetener 11A and the tea 10A have been sufficiently dissolved. The user then consumes the mixture.

The third exemplary embodiment comprises pre-measured quantities of tea 10A and a sweetener 11A in a large tea bag 12, such that an entire pot of tea may be made. The large tea bag 12 is preferably packaged individually in packets, with a plurality of the packets, such as 12 packets, provided in a box.

The fourth exemplary embodiment, like the third exemplary embodiment, comprises pre-measured quantities of tea 10A and sweetener 11A in a large tea bag 12. The tea 10A is stored separately in a tea section 15 from the sweetener 11A in a sweetener section 14. The tea section 15 is separated from the sweetener section 14 by a divider 16.

To use the third or fourth exemplary embodiment, the user opens the packet and places the large tea bag 12 in a teapot full of hot water. The user then agitates the large tea bag by stirring the water until the sweetener and the tea have been sufficiently dissolved. The user then serves the mixture in cups.

The tea bag 10, the sweetener bag 11, and the large tea bag 12 are preferably manufactured from a flexible, disposable material such as filter paper. The label 13 is preferably manufactured from a flexible, disposable material such as cardstock or paper. Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. A pre-sweetened tea bag comprising:
a. a tea formulation;
b. said tea formulation containing tea;
c. said tea formulation further containing a sweetener;
d. at least one bag; and
e. said tea formulation being held within said bag.

2. The pre-sweetened tea bag of claim 1, wherein said bag is configured and sized for making a single cup of tea.

3. The pre-sweetened tea bag of claim 2, wherein said bag is two bags, a tea bag and a sweetener bag; said tea bag and said sweetener bag being of the same size and shape; said tea bag and said sweetener bag being separate from one another and affixed together; said tea being stored within said tea bag; and said sweetener being stored within said sweetener bag.

4. The pre-sweetened tea bag of claim 1, further comprising a label; said label being connected to said bag via a string and configured to remove said bag after brewing.

5. The pre-sweetened tea bag of claim 2, further comprising a label; said label being connected to said bag via a string and configured to remove said bag after brewing.

6. The pre-sweetened tea bag of claim 3, further comprising a label; said label being connected to said bag via a string and configured to remove said bag after brewing.

7. The pre-sweetened tea bag of claim 1, wherein said bag is configured and sized for making an entire pot of tea.

8. The pre-sweetened tea bag of claim 7, wherein said bag has two sections, a tea section and a sweetener section; said tea section and said sweetener section being separated by a divider; said tea section storing said tea; and said sweetener section storing said sweetener.
